(19) United States
(12) Patent Application Publication
(10) Pub. No.: US 2017/0275053 A1
(43) Pub. Date: Sep. 28, 2017

(54) Magnifying Container Assembly

(71) Applicants: Kevork Wartersian, West Bloomfield, MI (US); Harout Wartersian, West Bloomfield, MI (US)

(72) Inventors: Kevork Wartersian, West Bloomfield, MI (US); Harout Wartersian, West Bloomfield, MI (US)

(21) Appl. No.: 15/078,431

(22) Filed: Mar. 23, 2016

(51) Int. Cl. B65D 25/54; A61J 1/03; G02B 7/14

(52) U.S. Cl. CPC B65D 25/54; G02B 7/14; A61J 1/03

(57) ABSTRACT

A magnifying container assembly for storing and improving the visibility of items stored within the container assembly includes a base section and at least one wall section extending away from the base section. The base section and at least one wall section form an enclosure that can receive at least one item within the enclosure. At least a portion of the at least one wall section may include a transparent magnifying region that magnifies an item or items retained within the enclosure. The container may include a plurality of magnifying regions with differing degrees of magnifying powers. The base section may include grooves, ridges, or other retaining element or elements to retain an item in a particular position within the container. When an item is disposed within the container the at least one magnifying region facilitates and improves viewing of the contents of the container.

### CROSS-REFERENCE TO RELATED APPLICATIONS

None.

### FIELD OF THE DISCLOSURE

The present disclosure generally relates to containers, and, more particularly, to a container assembly that includes at least one magnifying component for improving viewing of the contents of the container.

### BACKGROUND

Containers, such as a box, a jar, and the like, are generally used for storing items. Often times receptacles include transparent materials to allow a person to view what is stored within the receptacle. These receptacles may be shaped in the form of a cylinder or cube, for example, with sides or surfaces that enclose the item or items to be stored in or the contents of the container. The sides or surfaces are generally flat and otherwise of a consistent thickness such that the sides or surfaces of these conventional containers, even if transparent, do not magnify the interior of the container and therefore do not significantly improve the visibility of the items held within or the contents of the container.

Certain items contain important identifying information. One example is a prescription medication bottle, which medication bottle necessarily includes a label that identifies the medicine within the bottle along with dosage instructions. There can be serious consequences for a user if he or she does not ingest the correct medication and/or if he or she takes an incorrect dosage. Accordingly, it is preferable that the contents of the label are easily viewable. Unfortunately, many users that are prescribed such medication are elderly and/or have poor vision, thereby making it difficult to read those instructions.

Solutions exist for storing prescription medication in container, such as pill boxes that include days of the week indicated on separate compartments. These boxes assist a user in knowing which medication to take on a particular day. However, they do not indicate to the user the type of medication or dosage amount. A need exists for a container or other means for holding medicine and/or prescription bottles that will assist the user in determining the particular medicine in the container and/or the contents of the label of a prescription bottle.

To improve the visibility of items in a container, a magnifying attachment for a container is a solution, such as the device shown in U.S. Patent 5,204,775 (McDevitt). While such solutions go toward solving the problem of improving the visibility of items within or the contents of the container, this approach has significant drawbacks. Notably, the attachment, being removable from the container, may easily be displaced and misplaced such that it becomes unavailable for a user. Furthermore, these sort of removable magnifying devices are necessarily structurally complex. Such devices require not only a magnifying element but also elements to connect or attach the device to a container. With the presence of such additional elements, the chances for malfunction or breakdown of the device increase as well.

Accordingly, there exists a need for a magnifying container assembly that magnifies and otherwise facilitates identification and viewing of items stored within the container. Further, there exists a need for a magnifying container assembly that allows for improved viewing of the contents of the container themselves. Additionally, there exists a need for a magnifying container assembly that is structurally simple while remaining able to accommodate containers and items of a variety of sizes a configurations.

### SUMMARY OF THE DISCLOSURE

In view of the foregoing disadvantages of the prior art, a magnifying container assembly is disclosed. The assembly includes a base section and at least one wall section extending away from the base section. The base section and at least one wall section form an enclosure that can receive at least one item within the enclosure. At least a portion of the at least one wall section includes a transparent magnifying region that magnifies an item or items retained within the enclosure. The at least one magnifying region preferably comprises a lens, and in an embodiment, a bi-convex lens for providing for magnification of the interior of the enclosure. The at least one magnifying region may comprise a constant magnification power throughout the section. In another embodiment, the at least one magnifying region comprises a plurality of regions of different magnifying power. In yet another embodiment, the at least one magnifying region comprises uninterrupted transitions from areas with differing degrees of magnifying power. In an embodiment, the magnifying region allows for removal of the lens so that lenses of differing magnifying powers may be selectively installed in the magnifying region to adjust the magnifying power of the container. The disclosure as described provides a convenient and efficient way by which a user may easily identify items stored within the container assembly as aspects of those items are magnified by the at least one magnifying region. In an embodiment, a user may store a prescription medication bottle or vial within the magnifying container assembly, to allow for magnification, and therefore, easier reading, of the label of the prescription medication container to ensure that the user is taking the proper medication and/or a prescribed dosage of the medication.

In an embodiment, the base section of the magnifying container assembly is substantially flat. In another embodiment, the base section may be textured or curved. In yet another embodiment, the base section comprises at least one retaining element (such as grooves or ridges, for example) for securing an item within the enclosure formed by the base section and at least one magnifying region and for fixing the an item at a particular distance from the at least one magnifying region (such as a distance that retains the item at or near the focal point of the magnifying region, for example.) The base section may comprise a series of retaining elements (such as grooves or ridges) for holding an item at different distances from a magnifying region of a wall section or for accommodating different items of various sizes within the enclosure. In an embodiment, the base section may be removably attached to the at least one wall section. The container assembly may also comprise a lid for attaching to the at least one wall section and a handle that may attach to the at least one wall section.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 shows a magnifying container assembly in accordance with an exemplary embodiment of the present disclosure;

FIG. 2 shows a cutaway view of a magnifying container assembly in accordance with an exemplary embodiment of the present disclosure

FIG. 2a shows a magnifying container assembly, in accordance with another exemplary embodiment of the present disclosure; and

FIG. 3 shows an exploded view of a magnifying container assembly comprising a plurality of wall sections and a plurality of magnifying regions, a lid and a handle, in accordance with an exemplary embodiment of the present disclosure.

Like reference numerals refer to like parts throughout the description of several views of the drawings.

### DETAILED DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

The present disclosure provides a magnifying container assembly for storing and displaying at least one item therein. The present disclosure may find its utility in magnifying items stored in and/or the contents of the container to allow a user to view such items or contents more easily.

The container assembly includes a base section and at least one wall section extending away from the base section. The base section and at least one wall section form an enclosure that can receive at least one item within the enclosure. At least a portion of the at least one wall section may include a transparent magnifying region that magnifies an item or items retained within the enclosure. The container may include a plurality of magnifying regions with differing degrees of magnifying powers. The base section may include grooves, ridges, or other retaining element or elements to retain an item in a particular position within the container. When an item is disposed within the container the at least one magnifying region facilitates and improves viewing of the contents of the container.

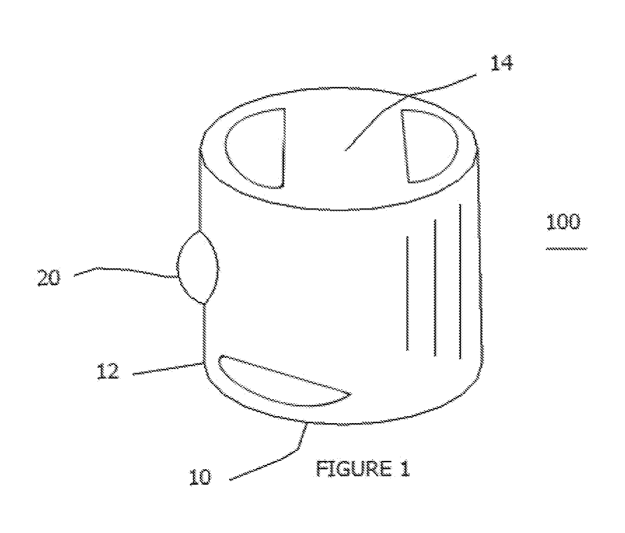

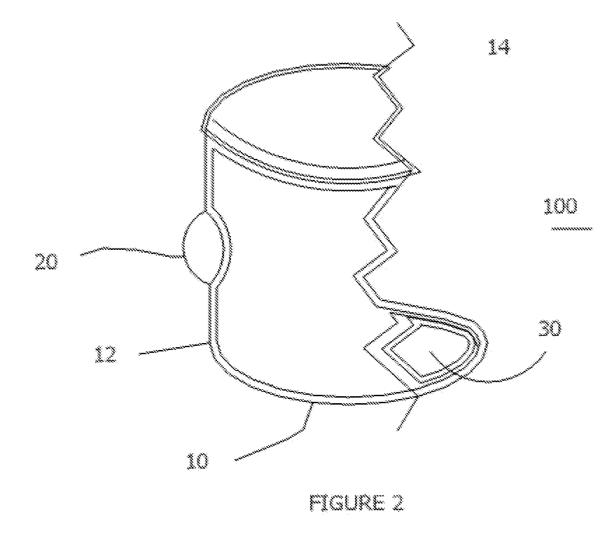

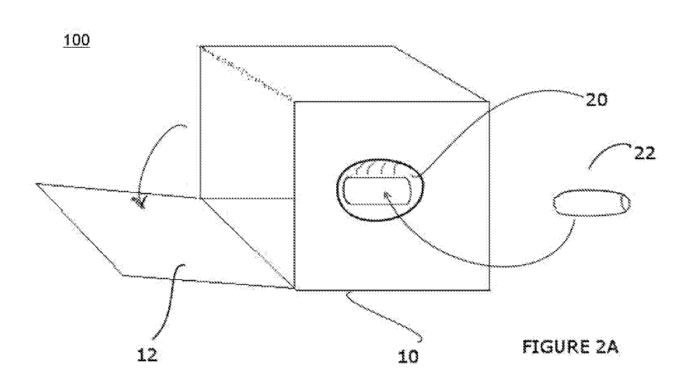

Referring now to FIGS. 1 and 2, a magnifying container assembly is shown at 100 in accordance with an embodiment of the present disclosure. The magnifying container assembly (hereinafter referred to as “container assembly”) 100 includes a base section 10 and at least one wall section 12 that extends away from the base section to form an enclosure 14. In a preferred embodiment, the enclosure 14 of the present disclosure is of a generally cylindrical shape, but it will be apparent that the enclosure may be of any geometric shape that facilitates receiving items. Further, the enclosure may comprise at least one open portion or side. At least one wall section 12 comprises a magnifying region 20. The magnifying region 20 may comprise a lens and is capable of magnifying the items stored within and/or the contents of the enclosure.

The base section 10 may further comprise at least one retaining element 30.

The at least one retaining element facilitates retaining an item in the container at a fixed position with respect to a magnifying region. In an embodiment, the retaining element comprises a ridge extending away from a portion of the base section. The configuration of the retaining element, and in an embodiment, the configuration of the ridge, may correspond to and/or be parallel to the interior perimeter of the enclosure. In another embodiment, the retaining element comprises a groove. In yet another embodiment, and as shown in FIG. 2, the retaining element comprises a plurality of concentric geometric shapes (such as circles.) In this exemplary embodiment, the concentric circles are disposed within said base section in varying depths, wherein a circle of the plurality of concentric circles with a smaller diameter is disposed at a greater depth than a circle of the plurality of concentric circles with a larger diameter. In this manner, the container assembly may receive items of various sizes and diameters and hold those items in a fixed position. In an embodiment, the location of the retaining element may be adjustable so that the position in which the retainer element holds an item may be adjusted to accommodate items of various sizes and/or different focal lengths or magnifying powers of a magnifying region. Such adjustability may be accomplished by removable attachment of a ridge, for example, or by having the concentric circle retaining element be a removable insert in the enclosure.

The base section 10 may comprise a substantially uninterrupted surface or may include apertures or other open areas. In an embodiment where the base section 10 comprises at least one retaining element 30, the at least one retaining element may be incorporated into the base section 10 so that at least one aperture or open area remains in the base section 10. In an embodiment where the base section 10 comprises a plurality of retaining elements 30, said retaining elements may be connected to one another so that at least one aperture or open area remains in the base section 10 and/or between the retaining elements.

The at least one magnifying region 20 of a wall section 12 is disposed within the wall section so that the magnifying region's focal point is within the enclosure. The magnifying region may be a lens that is incorporated into an area of the wall section 12. A wall section 12 may have no magnifying regions or may have more than one magnifying regions. In an embodiment where the wall section 12 comprises more than one magnifying region, one magnifying region may have a different focal point and/or magnifying power than another magnifying region, in order to accommodate magnification of items of different sizes within the enclosure. In another embodiment, magnifying region 20 may have areas within itself of different magnifying power and/or focal points (and may be configured similar to a “transition lens” as is known in the field of optometry.) Such a transition configuration allows for adjustment of the magnification of an item held within the enclosure. In yet another embodiment, and as shown in FIG. 2A a lens 22 may be removably inserted or attached to the magnifying region 20 so that lenses of various magnifications can be incorporated in the magnifying region 20 to adjust magnification of the magnifying region.

In an embodiment, at least one wall section 12 is provided. In another embodiment, a plurality of wall sections 12 is provided. The plurality of wall sections may be adjacent to one another or may be spaced apart from one another. A single wall section or the plurality of wall sections may form a cylinder, cube or any other geometric configuration that is capable of receiving items. It will be apparent that the base section will be configured to accommodate the wall sections and the disposition of the plurality of wall sections with respect to one another wall sections. The wall sections may be removably attached to the base section (via a snap-fit arrangement, for example, wherein corresponding fastener components are provided on the base section and wall section), so that a user may customize the configuration of the container and/or enclosure formed by the base section and wall sections. In another embodiment, a wall section may be fixedly or permanently attached to a base section. In such an embodiment, and as shown in FIG. 2A the wall section may be hingedly or foldably attached to the base section (by way of a seam, for example) to allow the wall section to fold away from the closure so that the container may be rendered into a substantially flat or planar configuration (for storing the container when not in use, for example). In such an embodiment, the wall section may be folded upwardly to form the enclosure, and may be retained in that position by way of engagement features that allow one wall section to attach to another upwardly-folded wall section, or by way of a lid such as the lid 40 described below.

In an embodiment, the plurality of wall sections 12 may each comprise a magnifying region 20. In an embodiment, the magnifying regions of each wall section may have the same magnifying power and/or focal point. In another embodiment, each magnifying region of the magnifying regions may have a different magnifying power/focal point. In such an embodiment, the magnifying regions may be disposed on the various wall sections such that the magnifying power/focal point of each magnifying region is in successive order, such that a user can rotate or turn the item within the container to easily adjust the magnification and appearance of the item in the container.

A magnifying region 20 may be disposed anywhere on a wall section 12 that facilitates magnification and viewing of an item that is received within the enclosure.

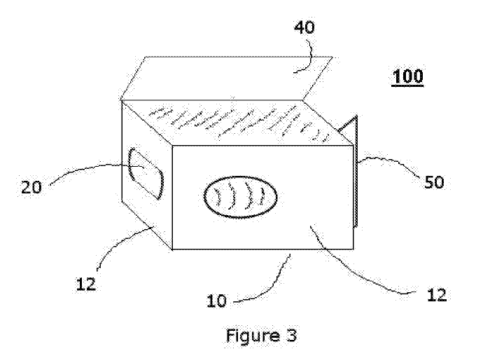

Referring to FIG. 3, the container assembly 100 may further comprise a lid 40 that may be disposed on the end of the wall section or portions that is distal to the base section. In an embodiment, where a wall section or portions extend away from the entire perimeter of the base section, the lid may be configured to correspond to the shape of the perimeter of the base section and to releaseably attach to the wall section or section such that the lid can close the enclosure entirely for safely retaining an item within the enclosure. The lid may be hingedly attached to a wall section, or may be removably attached (such as by a friction fit arrangement) to all wall sections. In another embodiment, a removable handle 50 is provided for attachment to a wall section to assist the user in manipulating the container assembly. In such an embodiment, it will be apparent that complementary engagement features on a wall section will be provided for temporary attachment of the handle 50 (such as snap-fit engagement features that allow ends or portions of the handle to be received therein).

In use, a user may place an item, such as a prescription medication bottle, within the enclosure of the container assembly. The user may then particularly dispose the medication bottle within the enclosure with respect to a magnifying region such that the magnifying region magnifies the label of the prescription bottle to improve the legibility of the label of the prescription bottle. The improved legibility improves the chance that the user will take the correct medicine and the proper dosage of such medicine, thus increasing the safety and health of the user. The plurality of magnifying regions and retaining elements allow for the container assembly to accommodate and magnify items of various sizes and items with labels and other contents of various sizes.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A magnifying container assembly for storing and displaying at least one item received within said assembly, the assembly comprising:
a container body, said container body having a base section and at least one wall section extending away from said base section to form an enclosure,
said at least one wall section comprising at least one magnifying region, wherein said at least one magnifying section is configured to magnify at least a portion of the enclosure,
wherein when an item is received within said enclosure said at least magnifying region magnifies the appearance of the item.

2. The assembly as claimed in claim 1, said base section further comprising at least one retainer element for retaining an item in a fixed position with respect to said enclosure.

3. The assembly as claimed in claim 2, wherein said at least one retainer element comprises one of a ridge and groove and a depression.

4. The assembly as claimed in claim 2, wherein said at least one retainer element comprises a plurality of concentric circles, wherein said concentric circles are disposed within said base section in varying depths, wherein a circle of the plurality of concentric circles with a smaller diameter is disposed at a greater depth than a circle of the plurality of concentric circles with a larger diameter.

5. The assembly as claimed in claim 2, wherein the position of said at least one retainer element is adjustable with respect to said enclosure.

6. The assembly as claimed in claim 2, the assembly comprising a plurality of retaining elements, wherein said base section comprises at least one aperture and wherein said plurality of retaining elements are connected to one another such that said at least one aperture of said base section remains open.

7. The assembly as claimed in claim 1, wherein said base section comprises at least one of a substantially flat surface, a substantially uninterrupted surface, a surface with at least one aperture theron, a textured surface, and a curved surface.

8. The assembly as claimed in claim 1, wherein said at least one magnifying region comprises a removable lens.

9. The assembly as claimed in claim 1, wherein said at least one magnifying region comprises a plurality of magnifying regions adjacent to one another, each magnifying region of the plurality magnifying regions having a different magnifying power than the other magnifying regions.

10. The assembly as claimed in claim 1, said assembly further comprising at least one of a lid and a handle.

11. The assembly as claimed in claim 1, wherein said at least one wall section is one of removably attached to said base section and hingedly attached to said base section.

12. A magnifying container assembly for storing and displaying at least one item received within said assembly, the assembly comprising:
a container body, said container body having a base section and at least a first wall section and a second wall section extending away from said base section to form an enclosure,
wherein at least one of said first wall section and second wall section comprises at least one magnifying region, wherein said at least one magnifying section is configured to magnify at least a portion of the enclosure,
wherein when an item is received within said enclosure said at least magnifying region magnifies the appearance of the item.

13. The assembly as claimed in claim 12, said base section further comprising at least one retainer element for retaining an item in a fixed position with respect to said enclosure.

14. The assembly as claimed in claim 13, wherein said at least one retainer element comprises one of a ridge and groove and a depression.

15. The assembly as claimed in claim 13, wherein said at least one retainer element comprises a plurality of concentric circles, wherein said concentric circles are disposed within said base section in varying depths, wherein a circle of the plurality of concentric circles with a smaller diameter is disposed at a greater depth than a circle of the plurality of concentric circles with a larger diameter.

16. The assembly as claimed in claim 13, wherein the position of said at least one retainer element is adjustable with respect to said enclosure.

17. The assembly as claimed in claim 13, the assembly comprising a plurality of retaining elements, wherein said base section comprises at least one aperture and wherein said plurality of retaining elements are connected to one another such that said at least one aperture of said base section remains open.

18. The assembly as claimed in claim 12, wherein said base section comprises at least one of a substantially flat surface, a substantially uninterrupted surface, a surface with at least one aperture theron, a textured surface, and a curved surface.

19. The assembly as claimed in claim 12, wherein said at least one magnifying region comprises a removable lens.

20. The assembly as claimed in claim 12, wherein said at least one magnifying region comprises a plurality of magnifying regions adjacent to one another, each magnifying region of the plurality magnifying regions having a different magnifying power than the other magnifying regions.

21. The assembly as claimed in claim 12, said assembly further comprising at least one of a lid and a handle.

22. The assembly as claimed in claim 12, wherein said first wall section and second wall section are disposed one of against one another and apart from one another.

23. The assembly as claimed in claim 12, said assembly comprising additional wall sections, at least one of said additional wall sections comprising a magnifying region.

24. The assembly as claimed in claim 12, wherein at least one of said first wall section and second wall section is one of removably attached to said base section and hingedly attached to said base section..
